(19) United States
(12) Patent Application Publication
(10) Pub. No.: US 2018/0054281 A1
(43) Pub. Date: Feb. 22, 2018

(54) METHOD TO TRANSMIT CHANNEL STATE INFORMATION REFERENCE SIGNALS IN LARGE MIMO SYSTEMS

(71) Applicant: Futurewei Technologies, Inc., Plano, TX (US)

(72) Inventor: SaiRamesh Nammi, Bedminster, NJ (US)

(73) Assignee: Futurewei Technologies, Inc., Plano, TX (US)

(21) Appl. No.: 15/241,945

(22) Filed: Aug. 19, 2016

(51) Int. Cl. H04L 5/00; H04B 7/06; H04W 72/04

(52) U.S. Cl. CPC H04L 5/005; H04W 72/0413; H04W 72/042; H04B 7/0626

(57) ABSTRACT

The disclosure relates to technology for transmitting a channel state information reference signal in a communications network. A channel state information reference signal period is computed based on an estimated Doppler metric corresponding to one or more user equipment in the network. The one or more user equipment are grouped into ranges based on the estimated Doppler metric corresponding to a respective one of the one or more user equipment. The one or more user equipment in each group are then configured to receive the channel state information reference signal with the corresponding channel state information reference signal period based on the Doppler metric, and the channel state information reference signal is transmitted to the one or more user equipment according to the channel state information reference signal period.

### BACKGROUND

The third generation partnership project (3GPP), and specifically 3GPP LTE, aims to improve the universal mobile telecommunications system (UMTS) standard. The 3GPP LTE radio interface offers high peak data rates, low delays and an increase in spectral efficiencies. The LTE ecosystem supports both frequency division duplex (FDD) and time division duplex (TDD). This enables operators to exploit both paired and unpaired spectrums since LTE supports 6 bandwidths.

Multiple access schemes, as provided in systems such as LTE, also allow for performance enhancing scheduling strategies. For example, Frequency Selective Scheduling (FSS) can be used to schedule a user over sub-carriers (or part of the bandwidth) that provides maximum channel gains to that user (and avoid regions of low channel gain). The channel response is measured and the scheduler utilizes this information to intelligently assign resources to users over parts of the bandwidth that maximize their signal-to-noise ratios (and spectral efficiency). In other words, the end to end performance of a multi-carrier system like LTE relies significantly on sub-carrier allocation techniques and transmission modes.

In a downlink transmission of such a telecommunications system, a common reference signal (CRS) for user equipment (UE) performs channel estimation for demodulation of a physical downlink control channel (PDCCH) and other common channels, as well as to measure feedback. Additionally, a channel state information reference signal (CSI-RS) may be used to measure the channel status, especially when multiple transmission antennas exist. CSI-RS may measure parameters and feedback information such as precoding matrix indicator (PMI), channel quality indicator (CQI), and rank indicator (RI) of the precoding matrix. CSI-RS can support up to 8 transmission antennas, whereas CRS can only support 4 transmission antennas.

### BRIEF SUMMARY

In one embodiment, the present technology relates to a method of transmitting a channel state information reference signal in a communications network, comprising computing a channel state information reference signal period based on an estimated Doppler metric corresponding to one or more user equipment in the network; grouping the one or more user equipment into ranges based on the estimated Doppler metric corresponding to a respective one of the one or more user equipment; configuring the one or more user equipment in each group to receive the channel state information reference signal with the corresponding channel state information reference signal period based on the Doppler metric; and transmitting the channel state information reference signal to the one or more user equipment according to the channel state information reference signal period.

In another embodiment, there is a base station for transmitting a channel state information reference signal in a communications network, comprising a memory storage comprising instructions; and one or more processors coupled to the memory that execute the instructions to compute a channel state information reference signal period based on an estimated Doppler metric corresponding to one or more user equipment in the network; group the one or more user equipment into ranges based on the estimated Doppler metric corresponding to a respective one of the one or more user equipment; configure the one or more user equipment in each group to receive the channel state information reference signal with the corresponding channel state information reference signal period based on the Doppler metric; and transmit the channel state information reference signal to the one or more user equipment according to the channel state information reference signal period.

In still another embodiment, there is a non-transitory computer-readable medium storing computer instructions for transmitting a channel state information reference signal in a communications network, that when executed by one or more processors, causes the one or more processors to perform the steps of computing a channel state information reference signal period based on an estimated Doppler metric corresponding to one or more user equipment in the network; grouping the one or more user equipment into ranges based on the estimated Doppler metric corresponding to a respective one of the one or more user equipment; configuring the one or more user equipment in each group to receive the channel state information reference signal with the corresponding channel state information reference signal period based on the Doppler metric; and transmitting the channel state information reference signal to the one or more user equipment according to the channel state information reference signal period.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1 illustrates a wireless network for communicating data.

FIG. 2 illustrates an example of a physical layer diagram in accordance with an embodiment of the disclosure.

FIG. 3 illustrates a message sequence diagram between a base station and user equipment during downlink data transfer.

FIG. 4 illustrates a downlink radio frame to transmit a periodic channel state information reference signal.

FIG. 5 illustrates a grouping of user equipment into Doppler frequency zones.

FIG. 6A illustrates a flow diagram of configuring user equipment to receive channel state information reference signals.

FIG. 6B illustrates a flow chart for estimating a Doppler metric of user equipment.

FIG. 7 illustrates a flow diagram of reporting channel state information at user equipment.

FIGS. 8A and 8B illustrate the impact of CSI-RS periodicity on average sector throughput with wideband and sub-band scheduling.

FIG. 9A illustrates example user equipment that may implement the methods and teachings according to this disclosure.

FIG. 9B illustrates example base station that may implement the methods and teachings according to this disclosure.

FIG. 10 illustrates a block diagram of a network system that can be used to implement various embodiments.

### DETAILED DESCRIPTION

The present technology, generally described, relates to technology for transmitting channel state information reference signals in large MIMO systems.

The technology groups UEs capable of receiving a CSI-RS based on a computed Doppler metric. Each UE having an estimated Doppler metric falling within a defined range will be placed in the same group. Each group of UEs may then be configured with a different CSI-RS period. That is, the CSI-RS period may be set based on the UE Doppler frequency (i.e., the base station computes the Doppler metric of the UE and sets the CSI-RS period based on the Doppler frequency). By grouping the UEs in this manner, a base station or serving cell may transmit a CSI-RS to a UE at a rate at which the UE's CSI is expected to change. Accordingly, the capacity of the system may be improved by utilizing system resources to otherwise transmit data. Additionally, inter cell interference may be reduced due to less frequent transmission of CSI-RS.

It is understood that the present embodiments of the invention may be implemented in many different forms and should not be construed as being limited to the embodiments set forth herein. Rather, these embodiments are provided so that this disclosure will be thorough and complete and will fully convey the invention to those skilled in the art. Indeed, the described embodiments of the invention are intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details or with equivalent implementations.

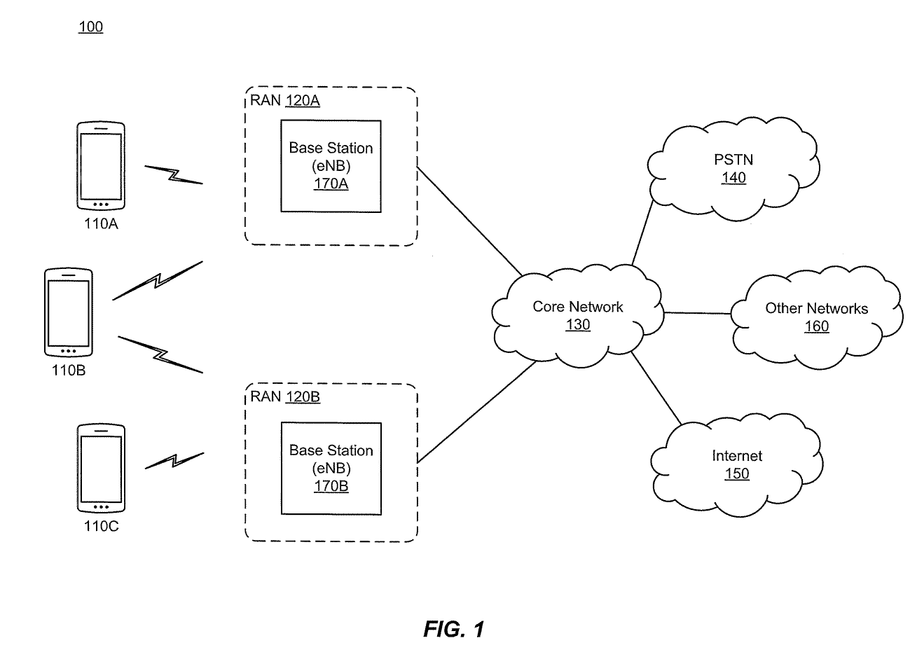

FIG. 1 illustrates a wireless network for communicating data. The communication system 100 includes, for example, UE 110A-110C, radio access networks (RANs) 120A-120B, a core network 130, a public switched telephone network (PSTN) 140, the Internet 150, and other networks 160. Additional or alternative networks include private and public data-packet networks including corporate intranets. While certain numbers of these components or elements are shown in the figure, any number of these components or elements may be included in the system 100.

System 100 enables multiple wireless users to transmit and receive data and other content. The system 100 may implement one or more channel access methods, such as but not limited to code division multiple access (CDMA), time division multiple access (TDMA), frequency division multiple access (FDMA), orthogonal FDMA (OFDMA), or single-carrier FDMA (SC-FDMA).

The UEs 110A-110C are configured to operate and/or communicate in the system 100. For example, the UEs 110A-110C are configured to transmit and/or receive wireless signals or wired signals. Each UE 110A-110C represents any suitable end user device and may include such devices (or may be referred to) as a user equipment/device (UE), wireless transmit/receive unit (WTRU), mobile station, fixed or mobile subscriber unit, pager, cellular telephone, personal digital assistant (PDA), smartphone, laptop, computer, touchpad, wireless sensor, or consumer electronics device.

In the depicted embodiment, the RANs 120A-120B include one or more base stations 170A, 170B (collectively, base stations 170), respectively. Each of the base stations 170 is configured to wirelessly interface with one or more of the UEs 110A, 110B, 110C (collectively, UEs 110) to enable access to the core network 130, the PSTN 140, the Internet 150, and/or the other networks 160. For example, the base stations (BSs) 170 may include one or more of several well-known devices, such as a base transceiver station (BTS), a Node-B (NodeB), an evolved NodeB (eNB), a Home NodeB, a Home eNodeB, a site controller, an access point (AP), or a wireless router, or a server, router, switch, or other processing entity with a wired or wireless network.

In one embodiment, the base station 170A forms part of the RAN 120A, which may include other base stations, elements, and/or devices. Similarly, the base station 170B forms part of the RAN 120B, which may include other base stations, elements, and/or devices. Each of the base stations 170 operates to transmit and/or receive wireless signals within a particular geographic region or area, sometimes referred to as a “cell.” In some embodiments, multiple-input multiple-output (MIMO) technology may be employed having multiple transceivers for each cell.

The base stations 170 communicate with one or more of the UEs 110 over one or more air interfaces (not shown) using wireless communication links. The air interfaces may utilize any suitable radio access technology.

It is contemplated that the system 100 may use multiple channel access functionality, including for example schemes in which the base stations 170 and UEs 110 are configured to implement the Long Term Evolution wireless communication standard (LTE), LTE Advanced (LTE-A), and/or LTE Broadcast (LTE-B). In other embodiments, the base stations 170 and UEs 110 are configured to implement UMTS, HSPA, or HSPA+standards and protocols. Of course, other multiple access schemes and wireless protocols may be utilized.

The RANs 120A-120B are in communication with the core network 130 to provide the UEs 110 with voice, data, application, Voice over Internet Protocol (VoIP), or other services. As appreciated, the RANs 120A-120B and/or the core network 130 may be in direct or indirect communication with one or more other RANs (not shown). The core network 130 may also serve as a gateway access for other networks (such as PSTN 140, Internet 150, and other networks 160). In addition, some or all of the UEs 110 may include functionality for communicating with different wireless networks over different wireless links using different wireless technologies and/or protocols.

In one embodiment, the base stations 170 comprise a carrier aggregation component (not shown) that is configured to provide service for a plurality of UEs 110 and, more specifically, to select and allocate carriers as aggregated carriers for a UE 110. More specifically, the carrier configuration component of base stations 170 may be configured to receive or determine a carrier aggregation capability of a selected UE 110. The carrier aggregation component operating at the base stations 170 are operable to configure a plurality of component carriers at the base stations 170 for the selected UE 110 based on the carrier aggregation capability of the selected UE 110. Based on the selected UE(s) capability or capabilities, the base stations 170 are configured to generate and broadcast a component carrier configuration message containing component carrier configuration information that is common to the UEs 110 that specifies aggregated carriers for at least one of uplink and downlink communications.

In another embodiment, base stations 170 generate and transmit component carrier configuration information that is specific to the selected UE 110. Additionally, the carrier aggregation component may be configured to select or allocate component carriers for the selected UE 110 based on at least one of quality of service needs and bandwidth of the selected UE 110. Such quality of service needs and/or required bandwidth may be specified by the UE 110 or may be inferred by a data type or data source that is to be transmitted.

Although FIG. 1 illustrates one example of a communication system, various changes may be made to FIG. 1. For example, the communication system 100 could include any number of UEs, base stations, networks, or other components in any suitable configuration.

It is also appreciated that the term UE may refer to any type of wireless device communicating with a radio network node in a cellular or mobile communication system. Non-limiting examples of a UE are a target device, device-to-device (D2D) UE, machine type UE or UE capable of machine-to-machine (M2M) communication, PDA, iPAD, Tablet, mobile terminals, smart phone, laptop embedded equipped (LEE), laptop mounted equipment (LME) and USB dongles.

Moreover, while the embodiments are described in particular for downlink data transmission scheme in LTE based systems, they are equally applicable to any radio access technology (RAT) or multi-RAT system. The embodiments are also applicable to single carrier as well as to multicarrier (MC) or carrier aggregation (CA) operation of the UE in which the UE is able to receive and/or transmit data to more than one serving cells using MIMO.

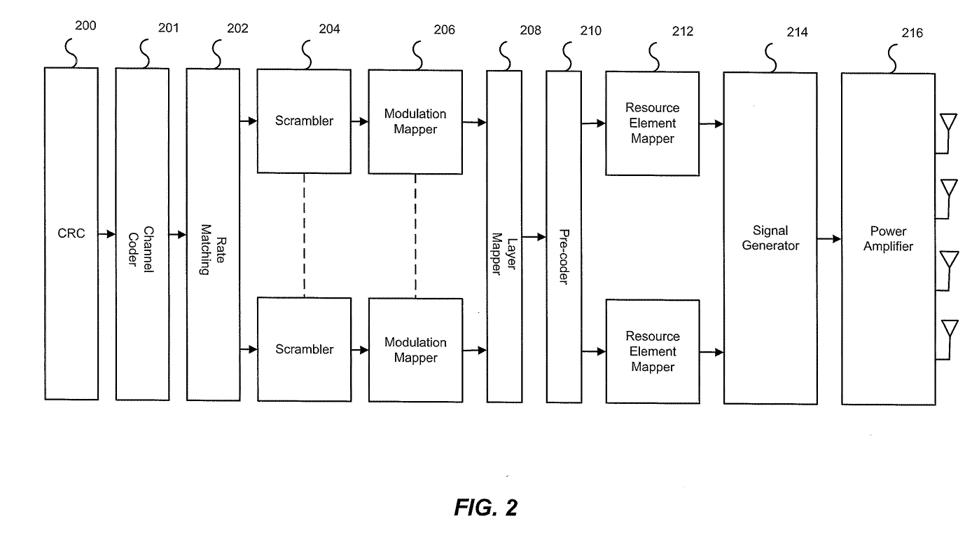

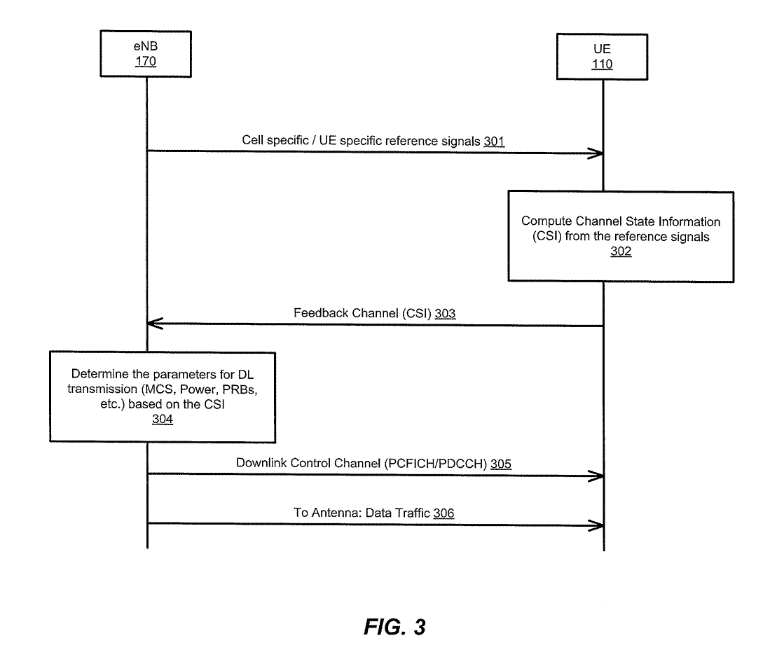

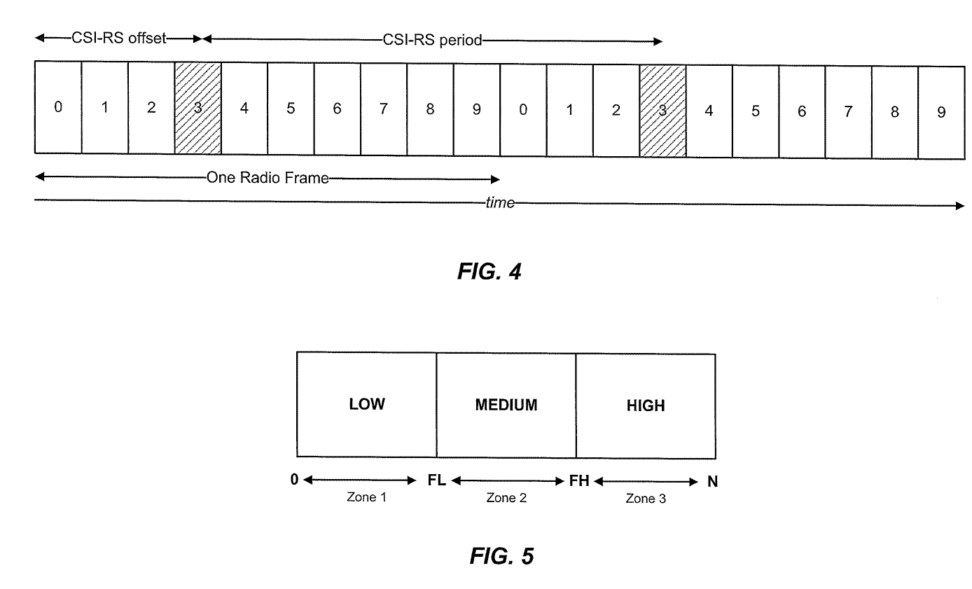

FIG. 2 illustrates an example of a physical layer diagram in accordance with an embodiment of the disclosure. Transport block data is passed through a cyclic redundancy check (CRC) 200 for error detection. The CRC 200 appends a CRC code to the transport block data received from a media access control (MAC) layer before being passed through the physical layer. The transport block is divided by a cyclic generator polynomial to generate parity bits. These parity bits are then appended to the end of transport block. A detailed description of transport block and code segmentation may be found in the description below with reference to FIG. 4.

The physical layer comprises a channel coder 201, a rate matcher 202, a scrambler 204, a modulation mapper 206, a layer mapper 208, a pre-coder 210, a resource element mapper 212, a signal generator (OFDMA) 214, and a power amplifier (PA) 216.

Channel coder 201 turbo codes the data with convolutional encoders having certain interleaving there-between, and the rate matcher 202 acts as a rate coordinator or buffer between preceding and succeeding transport blocks. The scrambler 204 produces a block of scrambled bits from the input bits.

Resource elements and resource blocks (RBs) define a physical channel. A RB is a collection of resource elements. A resource element is a single subcarrier over one OFDM symbol, and carries multiple modulated symbols with spatial multiplexing. In the frequency domain, a RB represents the smallest unit of resources that can be allocated. In LTE-A, a RB is a unit of time frequency resource, representing 180 KHz of spectrum bandwidth for the duration of a 0.5 millisecond slot.

Modulation mapper 206 maps the bit values of the input to complex modulation symbols with the modulation scheme specified. In one embodiment, the modulation scheme is Discrete Fourier Transform Spread Orthogonal Frequency Division Multiplexing (DFT-S-OFDM). In another embodiment, the modulation scheme is OFDM with aggressive PAPR reduction.

Spatial multiplexing creates multiple streams of data to individual UEs 110 on a single resource block (RB) effectively reusing each RB a number of times and thus increases spectral efficiency. Layer mapper 208 splits the data sequence into a number of layers.

Pre-coder 210 is based on transmit beam-forming concepts allowing multiple beams to be simultaneously transmitted in the M-MIMO system by a set of complex weighting matrices for combining the layers before transmission. Vector hopping is may be used for transmit diversity. The pre-coder 210 may, for example, vector hop with the weighting of the two antennas alternating between [+1, +1]^{T} and [+1, −1]^{T} from subframe to subframe, and resetting at the beginning of a new radio frame.

The resource element mapper 212 maps the data symbols, the reference signal symbols and control information symbols into a certain resource element in the resource grid. The signal generator 214 is coupled between the resource element mapper 212 and the PA array 216, such that a generated signal is transmitted by the PA antenna array using common broadcast channels (e.g. PSS, SSS, PBCH, PDCCH and PDSCH) over a narrow sub-band resource. The signal generator 214, which may also be referred to as the radio front end (RFE), converts digital signals to analog signals and up-converts, amplifies and filters the signals to radio frequency (RF) for transmission.

For example, LTE systems support transmission of a maximum of two codewords in the downlink channel, where a codeword is defined as an information block appended with a CRC. Each codeword is separately segmented and coded using turbo coding and the coded bits from each codeword are scrambled separately, as explained above. The complex-valued modulation symbols for each of the codewords to be transmitted are mapped onto one or multiple layers using layer mapper 208. The complex-valued modulation symbols d^{(q)}(0), . . . , d^{(q)}(M^{(q)}_{symb}31 1) for codeword q are mapped onto the layers x(i)=[x⁽⁰⁾(i) . . . x⁽⁰⁻¹⁾(i)]^{T}, i=0, 1, . . . , M^{layer}_{symb}−1, where u is the number of layers and M^{layer}_{symb} is the number of modulation symbols per layer. The codeword to layer mapping is shown in Table 1 below.

Once the layer mapping is completed, the resultant symbols are pre-coded using the pre-coder 210. The pre-coded symbols are mapped to resource elements in the OFDM time frequency grid and the OFDM signal is generated at 214. The resulting signal is passed to the antenna ports.

TABLE 1
Codeword-to-Layer Mapping in LTE

| Number of | Number of | Codeword-to-layer mapping | |
|---|---|---|---|
| layers | codewords | i = 0, 1, . . . , M_{symb}^{layer} − 1 | |
| 1 | 1 | x⁽⁰⁾ (i) = d⁽⁰⁾ (i) | M_{symb}^{layer} = M_{symb}⁽⁰⁾ |
| 2 | 2 | x⁽⁰⁾ (i) = d⁽⁰⁾ (i) | M_{symb}^{layer} = M_{symb}⁽⁰⁾ = |
| | | x⁽¹⁾ (i) = d⁽¹⁾ (i) | M_{symb}⁽¹⁾ |
| 3 | 2 | x⁽⁰⁾ (i) = d⁽⁰⁾ (i) | M_{symb}^{layer} = M_{symb}⁽⁰⁾ = |
| | | x⁽¹⁾ (i) = d⁽¹⁾ (2i) | M_{symb}⁽¹⁾/2 |
| | | x⁽²⁾ (i) = d⁽¹⁾ (2i + 1) | |
| 4 | 2 | x⁽⁰⁾ (i) = d⁽⁰⁾ (2i) | M_{symb}^{layer} = M_{symb}⁽⁰⁾/2 = |
| | | x⁽¹⁾ (i) = d⁽⁰⁾ (2i + 1) | M_{symb}⁽¹⁾/2 |
| | | x⁽²⁾ (i) = d⁽¹⁾ (2i) | |
| | | x⁽³⁾ (i) = d⁽¹⁾ (2i + 1) | |
| 5 | 2 | x⁽⁰⁾ (i) = d⁽⁰⁾ (2i) | M_{symb}^{layer} = M_{symb}⁽⁰⁾/2 = |
| | | x⁽¹⁾ (i) = d⁽⁰⁾ (2i + 1) | M_{symb}⁽¹⁾/3 |
| | | x⁽²⁾ (i) = d⁽¹⁾ (3i) | |
| | | x⁽³⁾ (i) = d⁽¹⁾ (3i + 1) | |
| | | x⁽⁴⁾ (i) = d⁽¹⁾ (3i + 2) | |
| 6 | 2 | x⁽⁰⁾ (i) = d⁽⁰⁾ (3i) | M_{symb}^{layer} = M_{symb}⁽⁰⁾/3 = |
| | | x⁽¹⁾ (i) = d⁽⁰⁾ (3i + 1) | M_{symb}⁽¹⁾/3 |
| | | x⁽²⁾ (i) = d⁽⁰⁾ (3i + 2) | |
| | | x⁽³⁾ (i) = d⁽¹⁾ (3i) | |
| | | x⁽⁴⁾ (i) = d⁽¹⁾ (3i + 1) | |
| | | x⁽⁵⁾ (i) = d⁽¹⁾ (3i + 2) | |
| 7 | 2 | x⁽⁰⁾ (i) = d⁽⁰⁾ (3i) | M_{symb}^{layer} = M_{symb}⁽⁰⁾/3 = |
| | | x⁽¹⁾ (i) = d⁽⁰⁾ (3i + 1) | M_{symb}⁽¹⁾/4 |
| | | x⁽²⁾ (i) = d⁽⁰⁾ (3i + 2) | |
| | | x⁽³⁾ (i) = d⁽¹⁾ (4i) | |
| | | x⁽⁴⁾ (i) = d⁽¹⁾ (4i + 1) | |
| | | x⁽⁵⁾ (i) = d⁽¹⁾ (4i + 2) | |
| | | x⁽⁶⁾ (i) = d⁽¹⁾ (4i + 3) | |
| 8 | 2 | x⁽⁰⁾ (i) = d⁽⁰⁾ (4i) | M_{symb}^{layer} = M_{symb}⁽⁰⁾/4 = |
| | | x⁽¹⁾ (i) = d⁽⁰⁾ (4i + 1) | M_{symb}⁽¹⁾/4 |
| | | x⁽²⁾ (i) = d⁽⁰⁾ (4i + 2) | |
| | | x⁽³⁾ (i) = d⁽⁰⁾ (4i + 3) | |
| | | x⁽⁴⁾ (i) = d⁽¹⁾ (4i) | |
| | | x⁽⁵⁾ (i) = d⁽¹⁾ (4i + 1) | |
| | | x⁽⁶⁾ (i) = d⁽¹⁾ (4i + 2) | |
| | | x⁽⁷⁾ (i) = d⁽¹⁾ (4i + 3) | |

FIG. 3 illustrates a message sequence diagram between a base station and user equipment during downlink data transfer. Although the figure is discussed with reference to a downlink channel, it is appreciated that communication may also be in an uplink channel.

As shown, base station (eNB) 170 communicates cell-specific/UE-specific reference (or pilot) signals at 301. Downlink reference signals are predefined signals occupying specific resource elements within the downlink time-frequency grid. The LTE specification includes several types of downlink reference signals that are transmitted in different ways and used for different purposes by the receiving terminal (UE 110), including, but limited to the following.

One type of reference signal is a CRS, which is transmitted in every downlink subframe and in every resource block in the frequency domain, thus covering the entire cell bandwidth. The cell-specific reference signals can be used by the UE 110 for channel estimation for coherent demodulation of any downlink physical channel with a few exceptions, for example, during various transmission modes. The cell-specific reference signals can also be used by the terminal to acquire CSI, as explained below (302). Additionally, terminal measurements on cell-specific reference signals are used as the basis for cell-selection and handover decisions.

Another type of reference signal is a demodulation reference signal (DM-RS). These reference signals (also referred to as UE-specific reference signals) are used by UEs 110 for channel estimation for physical downlink shared channel (PDSCH) in various transmission modes.

Still another type of reference signal is a CSI-RS, which may be used by UEs 110 to acquire CSI in the case when demodulation reference signals are used for channel estimation. CSI-RS have a significantly lower time/frequency density, thus implying less overhead, compared to the cell-specific reference signals.

Using one or more of the above-identified reference signals, the UE 110 computes the CSI and parameters needed for CSI reporting at 302. The CSI report includes, for example, the CQI, PMI, and RI.

At 303, the CSI report is sent to the base station 170 via a feedback channel, such as a physical uplink control channel (PUCCH) for periodic CSI reporting or a physical uplink shared channel (PUSCH) for aperiodic CSI reporting. Once received, the base station 170 scheduler may use the information to choose the parameters, such as the modulation and coding scheme (MCS), power and physical resource blocks (PRBs), for scheduling of the UE 110. The base station 170 then sends the scheduling parameters to the UE 110 at 305 in the physical downlink control channel (PDCCH).

In one embodiment, before sending the parameters in the PDCCH, the base station 170 sends a control format indicator information on the physical control indicator channel (PCFICH), which is the physical channel providing the UEs 110 with information necessary to decode the set of PDCCHs. Subsequently, data transmission may occur between the base station 170 and the UE 110 at 306.

As alluded to above, the PDCCH carries information about the scheduling grants. For example, the information may include the number of MIMO layers scheduled, transport block sizes, modulation for each code word, parameters related to hybrid automatic repeat request (HARQ), sub-band locations and PMI corresponding to the sub-bands. Typically, the following information is transmitted by the downlink control information (DCI) format: localized/distributed virtual resource block (VRB) assignment flag, resource block assignment, modulation and coding scheme, HARQ process number, new data indicator, redundancy version, transmit power control (TPC) command for PUCCH, a downlink assignment index, and a pre-coding matrix index and number of layers.

It is appreciated, however, that each of the DCI formats may not use all the information as detailed above. Rather, the contents of PDCCH depends on a transmission mode and the DCI format.

As discussed above, CSI may also be reported in the PUCCH in which information is carried about HARQ-ACK information corresponding to the downlink data transmission and channel state information. The channel state information may include RI, CQI and PMI. Either PUCCH or PUSCH can be used to carry this information. Various modes for PUCCH and PUSCH may be used, which modes generally depend on the transmission mode and the formats configured via higher layer signaling.

FIG. 4 illustrates a downlink radio frame used to convey transmitted periodic channel state information reference signals. In the illustrated embodiment, the downlink radio frame includes, for example, 10 subframes, where a subframe includes two slots in the time domain. A time required for transmitting one subframe is defined as a Transmission Time Interval (TTI). For example, one subframe may have a length of 1 ms and one slot may have a length of 0.5 ms. One slot may include a plurality of OFDM symbols in the time domain and include a plurality of Resource Blocks (RBs) in the frequency domain. Since the 3GPP LTE system uses OFDMA in the downlink, the OFDM symbol indicates one symbol duration. The OFDM symbol may be called an SC-FDMA symbol or symbol duration. An RB is a resource allocation unit including a plurality of contiguous subcarriers in one slot. As appreciated, the structure of the radio frame is only exemplary. Accordingly, the number of subframes included in a radio frame, the number of slots included in a subframe or the number of symbols included in a slot may be changed in various manners.

As illustrated, the radio frame is divided into 10 subframes, subframe 0 to subframe 9. A base station, such as base stations 170, transmits a CSI-RS with a CSI-RS transmission period of 10 ms (i.e., in every 10 subframes). In this example, there is also a CSI-RS transmission offset of 3. Different base stations 170 may have different CSI-RS transmission offsets so that CSI-RSs transmitted from a plurality of cells are uniformly distributed in time. For example, if a CSI-RS is transmitted every 10 ms, its CSI-RS transmission offset may be one of 0 to 9.

A CSI-RS transmission offset indicates a subframe in which base station 170 starts CSI-RS transmission in every predetermined period. When the base station 170 signals a CSI-RS transmission period (and offset) to a UE 110, the UE 110 may receive a CSI-RS from the base station 170 in subframes determined by the CSI-RS transmission period (and offset). The UE 110 may measure a channel using the received CSI-RS and thus may report such information as a CQI, a PMI, and/or an RI to the base station 170, as noted above.

As the information related to the CSI-RS is cell-specific information common to UEs 110 within the cell, the CSI-RS transmission period (and offset) may be set separately for each individual CSI-RS configuration. In one embodiment, the CSI-RS transmission period (and offset) may be set as a group for each CSI-RS configuration, as explained below in more detail.

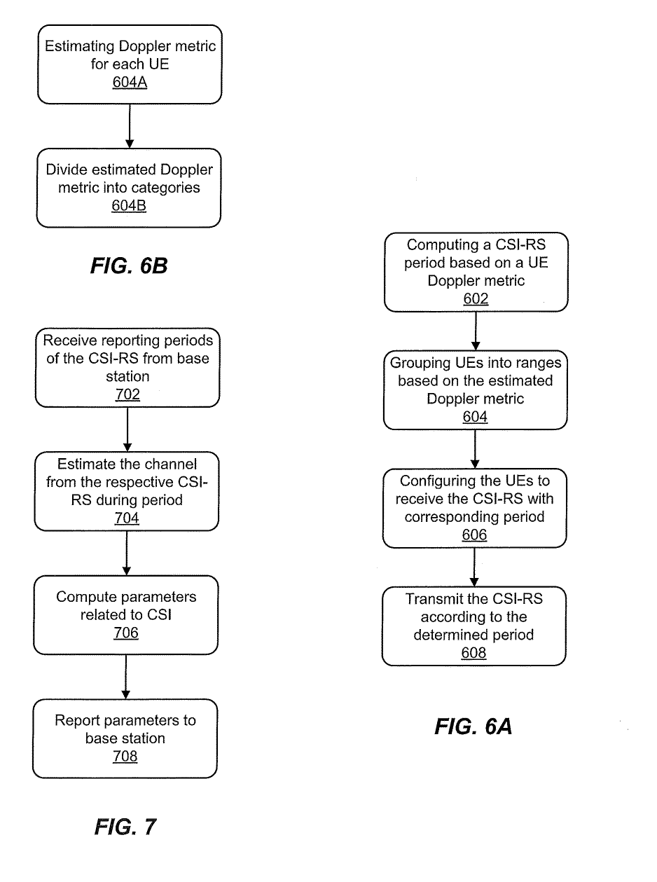

FIG. 5 illustrates a grouping of user equipment into Doppler frequency zones. In one embodiment, the CSI-RS period for each UE 110 is calculated based on the Doppler frequency. In order to calculate the CSI-RS period for a particular UE 110, the UEs 110 are categorized (grouped) into zones based on the estimated or predicted Doppler frequency (or speed) of the UE 110. Calculation of the Doppler frequency is discussed below with reference FIG. 6B. However, as appreciated, there are many well-known techniques to compute Doppler frequency.

In the example embodiment of FIG. 5, the estimates/predicted Doppler frequencies are divided into three categories: low (zone 1), medium (zone 2) and high (zone 3). Each zone represents a range of Doppler frequencies corresponding to the speed of one or more UEs 110. For example, zone 1 may include one or more low speed UEs 110, zone 2 may include one or more medium speed UEs 110 and zone 3 may include one or more high speed UEs 110. While the example of FIG. 5 illustrates three zones, there is no limit on the amount of zones that may be employed. That is, any number of more or less zones may be employed.

In the specific example of FIG. 5, the Doppler frequency for each UE 110 has been estimated/predicted by a base station 170. If f is the estimated/predicted Doppler frequency of a UE 110, the Doppler frequency range (speed) may be divided into three categories (zones) as follows:

Low Doppler Frequency Range: 0<f<FL

Medium Doppler Frequency Range: FL≦f<FH

High Doppler Frequency Range: FH≦f<+Inf,

where the frequency thresholds FL (frequency low) and FH (frequency high) may be predetermined or predicted by simulation or analysis.

In one embodiment, the Doppler frequency zone thresholds may depend on scheduling strategies and feedback (reporting) modes (or a combination thereof). A strategy defining in which way resources in time and frequency are allocated to a set of UEs 110 is commonly referred to as a scheduling algorithm. For example, scheduling algorithms that prioritize users having a good channel or radio condition perform channel dependent scheduling. Proportional fair scheduling, on the other hand, adds control of an overall fairness in the radio communications network by prioritizing UEs 110 not only based on a channel quality of the user equipment but also on an average rate of a transmission. These strategies may also be employed to set the aforementioned thresholds for each of the zones (FIG. 5). It is appreciated that the above-identified scheduling algorithms are non-limiting, and that other known scheduling algorithms may be employed.

Similarly, the information which is fed back to the base station 170 by the UE 110, including for example CQI and PMI, may be used to define the thresholds for each of the zones (FIG. 5). As discussed with reference to FIG. 3, the UE 110 may report the feedback information via a PUSCH or a PUCCH. The report types of the CQI/PMI for the PUSCH report mode and the PUCCH report mode are well known.

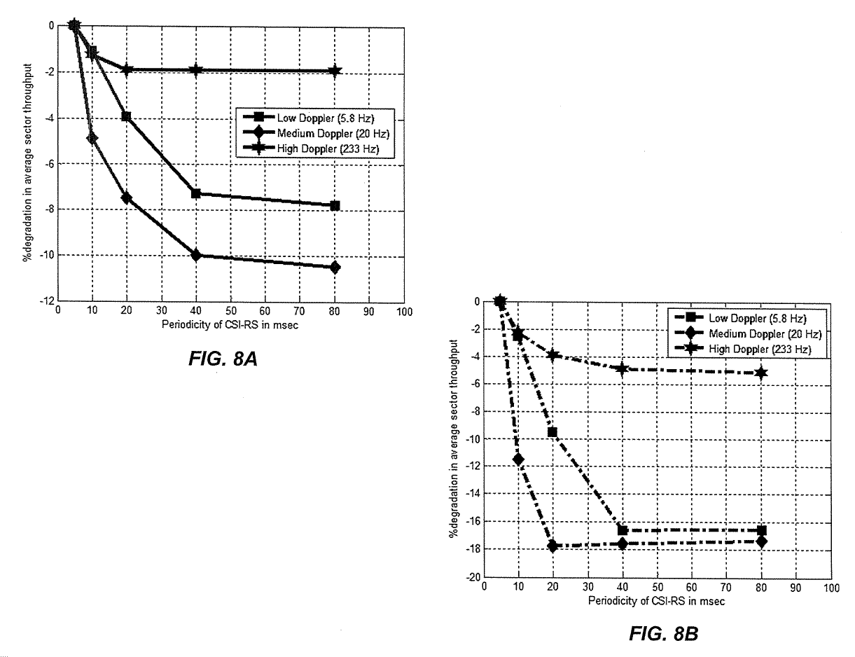

As one example of defining Doppler frequency zones, the base station 170 configures two sets of CSI-RS signals with periodicity values T1 and T2, where T1>T2. For example, T1=80 msec and T2=10 msec. As discussed below with reference to FIGS. 8A and 8B, setting a CS-RS period to a high value does not degrade the average sector throughput. Accordingly, UEs 110 grouped in zone 3 (high frequency range) are set such that the CSI-RS period is equal to T1. The base station 170 may then transmit one set of CSI-RS to the UEs 110 to indicate the relevant parameters related to these CSI-RS. For UEs 110 grouped in zone 2 (medium frequency range), the CSI-RS period is set to T2. The base station 170 then transmits a different set of CSI-RS and indicates the relevant parameters related to these CSI-RS.

In another example, the base station 170 configures three sets of CSI-RS signals with periodicity values T1, T2 and T3, where T1>T2>T3. For example T1=5 msec, T2=20 msec, and T3=80 msec. For High Doppler UEs 110 (in this example, UEs falling within zone 3), the CSI-RS period is set to T3 and a set of CSI-RS is transmitted to the UEs 110 to indicate the relevant parameters related to these CSI-RS. For medium Doppler frequency UEs 110 (in this example, UEs falling within zone 2), the CSI-RS period is set to T1 and a different set of CSI-RS is transmitted to the UE 110 to indicate the relevant parameters related to these CSI-RS. For low Doppler frequency UEs 110 (in this example, UEs falling within zone 1), the CSI-RS period is set to T2 and a different set of CSI-RS is transmitted to the UEs 110 indicate the relevant parameters related to these CSI-RS.

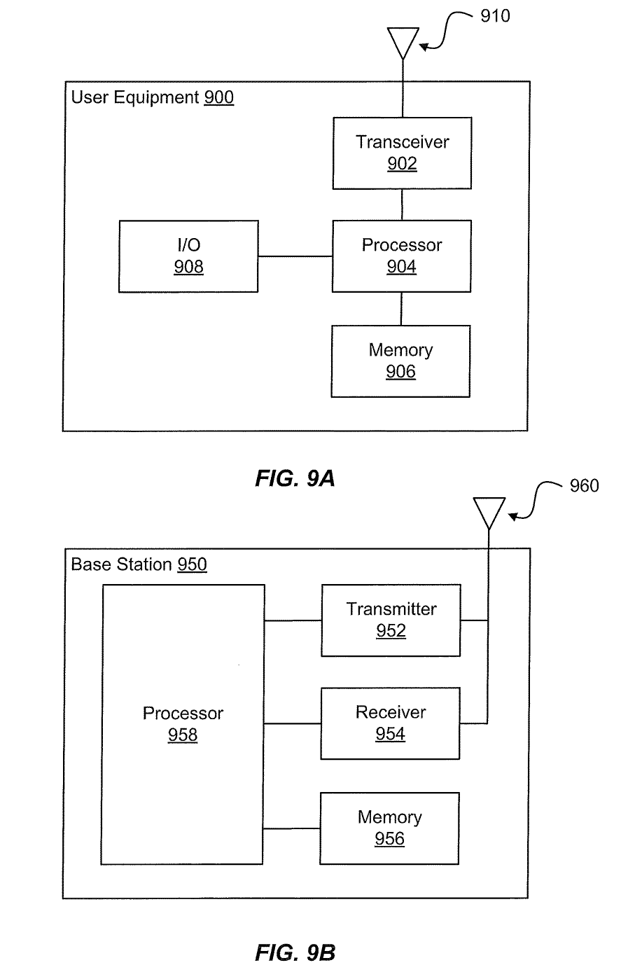

FIG. 6A illustrates a flow diagram of configuring user equipment to receive channel state information reference signals. In the disclosed embodiments, the methodology may be implemented by processor 904 of UE 900 or processor 958 of base station 950 (FIG. 9), although such implementation is not limited thereto.

In a communications system, such as communications system 100, the CSI-RSs may be transmitted periodically at every integer multiple of one subframe, or in a predetermined transmission pattern, to assist in reducing overhead of CSI-RS. The CSI-RS transmission period or pattern of the CSI-RSs may be configured, in one embodiment, by the base station 170 (or 900) based on a computed or measured UE 110 Doppler metric (speed), such as Doppler frequency, at 602.

At 604, the UEs 110 are grouped into ranges based on the estimated Doppler metric. That is, as described above with reference to FIG. 5, UEs falling within a same range are grouped together. For example, UEs 110 having a Doppler frequency between 0 and a threshold FL will be grouped together (zone 1), while UEs 110 having a Doppler frequency between threshold FL and threshold FH will be grouped together (zone 2).

After the UEs 110 are grouped according to Doppler frequency, the UEs 110 in each group are configured to receive the CSI-RS with the corresponding CSI-RS period based on the Doppler metric at 606. Subsequently, at 608, CSI-RS may be transmitted to the UEs 110 according to the CSI-RS period.

FIG. 6B illustrates a flow chart for estimating a Doppler metric of user equipment. At 604A, the Doppler metric is calculated for each UE 110, according to various methodologies. In one embodiment, the Doppler frequency is estimated from the time-varying amount of a received downlink pilot symbol, and the moving speed of a mobile terminal is calculated from the estimated Doppler frequency and the center frequency. The relationship between the movement speed V and the Doppler frequency Fd, the center frequency Fc, and the velocity of light c is given by expression: V=cf_{d}/f_{c}.

In another embodiment, the base station 170 can compute the direct speed of the UE 110, for example, by positioning or global positioning system (GPS) at multiple intervals. Then the Doppler frequency (Df) can computed as the average of the individual speed measurements, using the expression:

$${D}_{f} = \frac{1}{N} {\sum }_{i = 1}^{N} Di * {f}_{c} / C ,$$

where Dᵢ is the individual speed measurement in m/sec, f_{c} is the carrier frequency and C is the velocity of light in free space. N is the number of speed measurements.

In yet another embodiment, a rate of change of the uplink channel may be used to estimate Doppler frequency (speed). In this case, the base station 170 estimates the uplink channel such that he rate of change of the uplink channel predicts a measurement of the Doppler frequency for the UE 110.

Once the Doppler metrics are calculated for the UEs 110, they may be divided into categories (groups) for creating zones at 604B, as discussed above with reference to FIG. 5.

FIG. 7 illustrates a flow diagram of reporting channel state information at user equipment. Once the UE 110 receives the reporting periods of the CSI-RS from the base station 170, at 702, the UE 110 will estimate the channel from the respective CSI-RS during those periods at 704.

Once all of the elements of the channel matrix is formed, the UE 110 will compute the parameters related to CSI, at 706, for example CQI, RI, PMI, best sub-band indices, etc. The UE 110 then reports these values to the base station 170 either periodically using PUCCH or aperiodically using PUSCH, at 708, as explained above.

In one embodiment, the UE 110 can recommend to the base station 170 whether it is in low Doppler region, medium Doppler region or High Doppler region to thereby assist the base station 170 in determining the Doppler metric and the CSI-RS reporting period for the corresponding UE 110.

In another embodiment the UE determines the Doppler region and recommends the CSI-RS reporting period to the base station 170.

FIGS. 8A and 8B illustrate the impact of CSI-RS periodicity on average sector throughput with wideband and sub-band scheduling. In closed loop MIMO systems having different CSI-RS periods, performance loss occurs as a result of varying Doppler frequencies (speed) between UEs 110 and base stations 170.

FIG. 8A shows the throughput performance of a downlink channel in a MIMO system having two transmit antennas with wideband scheduling (in this example, in transmission mode 9). The percentage of degradation in average sector throughput is plotted in the vertical axis against the CSI-RS period (in msec) along the horizontal axis. Three different UE Doppler frequencies (speeds) are plotted in the graph of FIG. 8A, namely the low Doppler frequency, medium Doppler frequency and high Doppler frequency. As the CSI-RS period increases, the average sector throughput decreases. However, accordingly to the graph, the impact for low Doppler frequency UEs and for high Doppler frequency UEs is below 8% when approaching a CSI-RS of 80 msec. This is a result of slow speed UEs having slower channel changes. For high speed Doppler frequencies, on the other hand, the channel changes are fast enough such that the performance loss (degradation) is nearly the same for different CSI-RS periods. For medium Doppler frequency UEs, the percentage loss (degradation) in average sector throughput is severe. The severity is due to low CSI-RS periods in which the CQI reported by a UE is valid, but as the CSI-RS period increases the channel is outdated.

Following the examples set forth above with respect to FIG. 5, to have a performance loss (degradation) of less than 5% for each of the Doppler frequency ranges, the periods should be set to 20 msec for low Doppler UEs, 10 msec for medium Doppler UEs, and 80 msec for high Doppler UE, as illustrated.

FIG. 8B shows the throughput performance of a downlink channel in a MIMO system having two transmit antennas with sub-band scheduling. Similar to FIG. 8A, the low Doppler frequency, medium Doppler frequency and high Doppler frequency are also impacted by the changing periodicity of the CSI-RS. However, in the case of FIG. 8B, the percent of loss (degradation) is severe for each of the Doppler frequencies. For example, to ensure a performance loss of less than 10%, the periods should be set to 20 msec for low Doppler UEs, 5 msec for medium Doppler UEs and 80 msec for high Doppler UEs.

Accordingly, as explained above, the CSI-RS period in the disclosed technology is set based on the estimated/predicted UE Doppler frequency (i.e., the base station computes the Doppler metric of the UE and sets the CSI-RS period based on the Doppler frequency or range of frequencies).

FIG. 9A illustrates example user equipment that may implement the methods and teachings according to this disclosure. As shown in the figure, the UE 900 includes at least one processor 904. The processor 904 implements various processing operations of the UE 900. For example, the processor 804 may perform signal coding, data processing, power control, input/output processing, or any other functionality enabling the UE 900 to operate in the system 100 (FIG. 1). The processor 904 may include any suitable processing or computing device configured to perform one or more operations. For example, the processor 904 may include a microprocessor, microcontroller, digital signal processor, field programmable gate array, or application specific integrated circuit.

The UE 900 also includes at least one transceiver 902. The transceiver 902 is configured to modulate data or other content for transmission by at least one antenna 910. The transceiver 902 is also configured to demodulate data or other content received by the at least one antenna 910. Each transceiver 902 may include any suitable structure for generating signals for wireless transmission and/or processing signals received wirelessly. Each antenna 910 includes any suitable structure for transmitting and/or receiving wireless signals. It is appreciated that one or multiple transceivers 902 could be used in the UE 900, and one or multiple antennas 910 could be used in the UE 900. Although shown as a single functional unit, a transceiver 902 may also be implemented using at least one transmitter and at least one separate receiver.

The UE 900 further includes one or more input/output devices 908. The input/output devices 908 facilitate interaction with a user. Each input/output device 908 includes any suitable structure for providing information to or receiving information from a user, such as a speaker, microphone, keypad, keyboard, display, or touch screen.

In addition, the UE 900 includes at least one memory 906. The memory 906 stores instructions and data used, generated, or collected by the UE 900. For example, the memory 906 could store software or firmware instructions executed by the processor(s) 904 and data used to reduce or eliminate interference in incoming signals. Each memory 906 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

FIG. 9B illustrates example base station that may implement the methods and teachings according to this disclosure. As shown in the figure, the base station 950 includes at least one processor 958, at least one transmitter 952, at least one receiver 954, one or more antennas 960, and at least one memory 956. The processor 958 implements various processing operations of the base station 950, such as signal coding, data processing, power control, input/output processing, or any other functionality. Each processor 958 includes any suitable processing or computing device configured to perform one or more operations. Each processor 958 could, for example, include a microprocessor, microcontroller, digital signal processor, field programmable gate array, or application specific integrated circuit.

Each transmitter 952 includes any suitable structure for generating signals for wireless transmission to one or more UEs or other devices. Each receiver 954 includes any suitable structure for processing signals received wirelessly from one or more UEs or other devices. Although shown as separate components, at least one transmitter 952 and at least one receiver 954 could be combined into a transceiver. Each antenna 960 includes any suitable structure for transmitting and/or receiving wireless signals. While a common antenna 960 is shown here as being coupled to both the transmitter 952 and the receiver 954, one or more antennas 960 could be coupled to the transmitter(s) 952, and one or more separate antennas 860 could be coupled to the receiver(s) 954. Each memory 956 includes any suitable volatile and/or non-volatile storage and retrieval device(s).

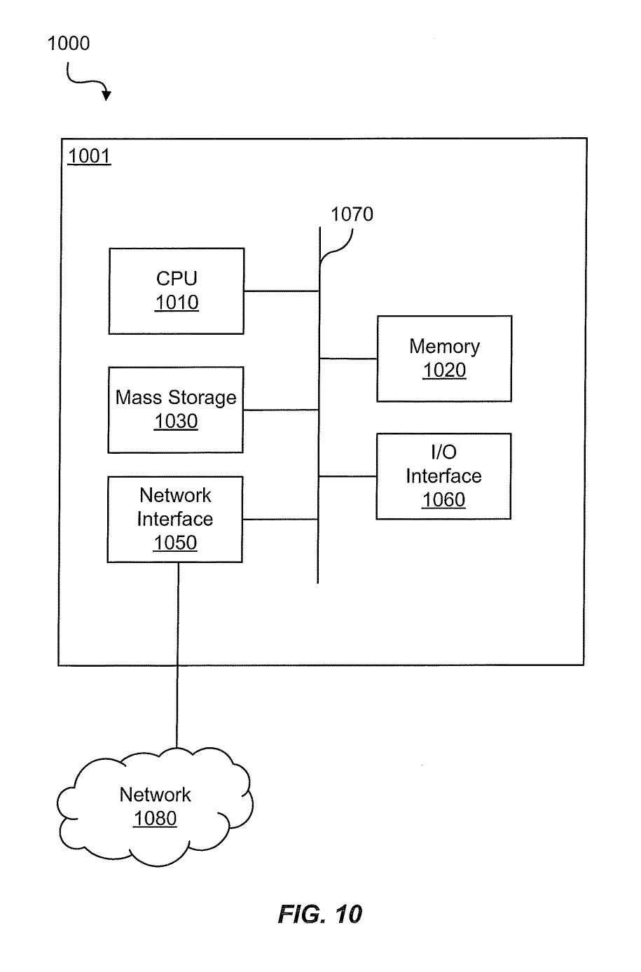

FIG. 10 is a block diagram of a network system that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The network system may comprise a processing unit 1001 equipped with one or more input/output devices, such as network interfaces, storage interfaces, and the like. The processing unit 1001 may include a central processing unit (CPU) 1010, a memory 1020, a mass storage device 1030, and an I/O interface 1060 connected to a bus. The bus may be one or more of any type of several bus architectures including a memory bus or memory controller, a peripheral bus or the like.

The CPU 1010 may comprise any type of electronic data processor. The memory 1020 may comprise any type of system memory such as static random access memory (SRAM), dynamic random access memory (DRAM), synchronous DRAM (SDRAM), read-only memory (ROM), a combination thereof, or the like. In an embodiment, the memory 1020 may include ROM for use at boot-up, and DRAM for program and data storage for use while executing programs. In embodiments, the memory 1020 is non-transitory. The mass storage device 1030 may comprise any type of storage device configured to store data, programs, and other information and to make the data, programs, and other information accessible via the bus. The mass storage device 1030 may comprise, for example, one or more of a solid state drive, hard disk drive, a magnetic disk drive, an optical disk drive, or the like.

The processing unit 1001 also includes one or more network interfaces 1050, which may comprise wired links, such as an Ethernet cable or the like, and/or wireless links to access nodes or one or more networks 1080. The network interface 1050 allows the processing unit 901 to communicate with remote units via the networks 1080. For example, the network interface 1050 may provide wireless communication via one or more transmitters/transmit antennas and one or more receivers/receive antennas. In an embodiment, the processing unit 1001 is coupled to a local-area network or a wide-area network for data processing and communications with remote devices, such as other processing units, the Internet, remote storage facilities, or the like.

There are many benefits to using embodiments of the present disclosure. For example, in the disclosed technology, the base station or the serving cell transmits the CSI-RS to a UE at a rate at which the UE's CSI is expected to change. Otherwise, these resources can be used for transmitting data to thereby improve the capacity of the system. In addition, the inter cell interference is reduced due to less frequent transmission of CSI-RS.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

In accordance with various embodiments of the present disclosure, the methods described herein may be implemented using a hardware computer system that executes software programs. Further, in a non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of transmitting a channel state information reference signal in a communications network, comprising:
computing a channel state information reference signal period based on an estimated Doppler metric corresponding to one or more user equipment in the network;
grouping the one or more user equipment into ranges based on the estimated Doppler metric corresponding to a respective one of the one or more user equipment;
configuring the one or more user equipment in each group to receive the channel state information reference signal with the corresponding channel state information reference signal period based on the Doppler metric; and
transmitting the channel state information reference signal to the one or more user equipment according to the channel state information reference signal period.

2. The method of claim 1, wherein the channel state information reference signal period is computed by calculating one of (a) a direct speed of a respective one of the one or more user equipment and (b) a rate of change of an uplink channel for a respective one of the one or more user equipment.

3. The method of claim 2, wherein the Doppler frequency is calculated according to the formula:
$${D}_{f} = \frac{1}{N} {\sum }_{i = 1}^{N} Di * {f}_{c} / C ,$$
where Dᵢ is an individual speed measurement of the one or more user equipment in m/sec, f_{c} is a carrier frequency, C is a velocity of light in free space, and N is a number of speed measurements.

4. The method of claim 1, wherein the grouping comprises dividing the computed Doppler metric into the ranges consisting of a low Doppler Frequency Range, a Medium Doppler Frequency Range and a High Doppler Frequency Range, and placing each of the one or more user equipment into a respective one of the ranges based on the Doppler metric of each of the one or more user equipment.

5. The method of claim 4, wherein the Doppler metric ranges are determined based on predetermined thresholds.

6. The method of claim 5, wherein the predetermined thresholds are determined based on at least one of scheduling strategy and feedback reports from the one or more user equipment.

7. The method of claim 1, wherein the configuring the one or more user equipment in each group comprises sending a single channel state information reference signal period for each of the ranges.

8. The method of claim 1, wherein the Doppler metric and ranges are computed by the one or more user equipment.

9. The method of claim 1, further comprising:
receiving a channel state information report generated from channel estimates and parameters computed at the one or more user equipment during the respective channel state information reference signal period and based on the channel state information reference signals;
transmitting scheduling parameters based on the channel state information report to the one or more user equipment on a downlink control channel; and
transmitting data to the one or more user equipment.

10. A base station for transmitting a channel state information reference signal in a communications network, comprising:
a memory storage comprising instructions; and
one or more processors coupled to the memory that execute the instructions to:
compute a channel state information reference signal period based on an estimated Doppler metric corresponding to one or more user equipment in the network;
group the one or more user equipment into ranges based on the estimated Doppler metric corresponding to a respective one of the one or more user equipment;
configure the one or more user equipment in each group to receive the channel state information reference signal with the corresponding channel state information reference signal period based on the Doppler metric; and
transmit the channel state information reference signal to the one or more user equipment according to the channel state information reference signal period.

11. The base station of claim 10, wherein the channel state information reference signal period is computed by calculating one of (a) a direct speed of a respective one of the one or more user equipment and (b) a rate of change of an uplink channel for a respective one of the one or more user equipment.

12. The base station of claim 11, wherein the Doppler frequency is calculated according to the formula:
$${D}_{f} = \frac{1}{N} {\sum }_{i = 1}^{N} Di * {f}_{c} / C ,$$
where Dᵢ is an individual speed measurement of the one or more user equipment in m/sec, f_{c} is a carrier frequency, C is a velocity of light in free space, and N is a number of speed measurements.

13. The base station of claim 10, wherein the grouping comprises dividing the computed Doppler metric into the ranges consisting of a low Doppler Frequency Range, a Medium Doppler Frequency Range and a High Doppler Frequency Range, and placing each of the one or more user equipment into a respective one of the ranges based on the Doppler metric of each of the one or more user equipment.

14. The base station of claim 13, wherein the Doppler metric ranges are determined based on predetermined thresholds.

15. The base station of claim 10, wherein the configuring the one or more user equipment in each group comprises sending a single channel state information reference signal period for each of the ranges.

16. The base station of claim 10, wherein the one or more processors coupled to the memory further execute the instructions to:
receive a channel state information report generated from channel estimates and parameters computed at the one or more user equipment during the respective channel state information reference signal period and based on the channel state information reference signals;
transmit scheduling parameters based on the channel state information report to the one or more user equipment on a downlink control channel; and
transmit data to the one or more user equipment.

17. A non-transitory computer-readable medium storing computer instructions for transmitting a channel state information reference signal in a communications network, that when executed by one or more processors, causes the one or more processors to perform the steps of:
computing a channel state information reference signal period based on an estimated Doppler metric corresponding to one or more user equipment in the network;
grouping the one or more user equipment into ranges based on the estimated Doppler metric corresponding to a respective one of the one or more user equipment;
configuring the one or more user equipment in each group to receive the channel state information reference signal with the corresponding channel state information reference signal period based on the Doppler metric; and
transmitting the channel state information reference signal to the one or more user equipment according to the channel state information reference signal period.

18. The non-transitory computer-readable medium of claim 17, wherein the channel state information reference signal period is computed by calculating one of (a) a direct speed of a respective one of the one or more user equipment and (b) a rate of change of an uplink channel for a respective one of the one or more user equipment.

19. The non-transitory computer-readable medium of claim 17, wherein the grouping comprises dividing the computed Doppler metric into the ranges consisting of a low Doppler Frequency Range, a Medium Doppler Frequency Range and a High Doppler Frequency Range, and placing each of the one or more user equipment into a respective one of the ranges based on the Doppler metric of each of the one or more user equipment.

20. The non-transitory computer-readable medium of claim 19, wherein the Doppler metric ranges are determined based on predetermined thresholds.

21. The non-transitory computer-readable medium of claim 17, wherein the configuring the one or more user equipment in each group comprises sending a single channel state information reference signal period for each of the ranges.

22. The non-transitory computer-readable medium of claim 17, further comprising:
receiving a channel state information report generated from channel estimates and parameters computed at the one or more user equipment during the respective channel state information reference signal period and based on the channel state information reference signals;
transmitting scheduling parameters based on the channel state information report to the one or more user equipment on a downlink control channel; and
transmitting data to the one or more user equipment.
